(19) United States
(12) Patent Application Publication
(10) Pub. No.: US 2024/0326310 A1
(43) Pub. Date: Oct. 3, 2024

(54) METHOD AND DEVICE FOR PROCESSING PLASTICS MATERIAL

(71) Applicant: Coperion GmbH, Stuttgart (DE)

(72) Inventors: Felix DREHER, Stuttgart (DE); Marina MATTA, Gemmingen (DE)

(73) Assignee: Coperion GmbH, Stuttgart (DE)

(21) Appl. No.: 18/287,595

(22) PCT Filed: Apr. 5, 2022
(86) PCT No.: PCT/EP2022/058926

§ 371 Date: Oct. 19, 2023

(30) Foreign Application Priority Data
Apr. 22, 2021 (EP) 21169919.4

(51) Int. Cl. B29C 48/25; B29C 48/375; B29C 48/40; B29C 48/76; C08J 11/04

(52) U.S. Cl. CPC B29C 48/267; B29C 48/375; B29C 48/40; B29C 48/76; C08J 11/04; C08J 2327/04

(57) ABSTRACT

A method for processing plastics material, in particular thermoplastic material, such as plastics recycling material and/or plastics waste, is disclosed comprising the following steps: supplying the plastics material into a screw-conveyor machine); supplying an additive for converting organic chlorides into inorganic chlorides into the screw-conveyor machine; plasticizing the supplied plastics material with the screw-conveyor machine to form a plastics melt, and mixing the plastics melt with the supplied additive with the screw-conveyor machine to form a mixture, wherein at least some of the organic chlorides contained in the plastics melt are converted into inorganic chlorides with the additive. A corresponding device for processing plastics material, in particular thermoplastic material, such as plastics recycling material and/or plastics waste, using a screw-conveyor machine is also disclosed.

### CROSS-REFERENCE TO RELATED APPLICATIONS

This application is a 35 U.S.C. § 371 national stage patent application of International Patent Application No. PCT/EP2022/058926, filed on Apr. 5, 2022, which is based on and claims priority to European Patent Application No. EP 21169919.4 filed on Apr. 22, 2021, the disclosures which are both incorporated by reference herein in their entirety.

### DESCRIPTION

The disclosure relates to a method for processing plastics material, in particular thermoplastic material, such as plastics recycling material and/or plastics waste. The disclosure also relates to a device for processing plastics material, in particular thermoplastic material, such as plastics recycling material and/or plastic waste, and to the use of such a device.

In chemical recycling, plastic waste, such as plastics recycling waste, which may have, for example, polyolefins, such as mixed polyolefins (MPO), and can no longer be recycled in a conventional manner by mechanical recycling, are fed to a pyrolysis reactor. As an alternative to pyrolysis, other material conversion processes, such as gasification, fluid catalytic cracking (FCC), or catalytic hydrothermal reactor technology (CAT-HTR) may be used. The aim of the pyrolysis is to convert long-chain polymers into short-chain oligomers, which may be separated from one another in a subsequent distillation step. Typically small plants are in operation, which are charged discontinuously with solid plastic waste, melted in the pyrolysis reactor and heated to the pyrolysis temperature. The pyrolysis reactor can also be charged using a single-shaft extruder which melts and heats the material.

Document EP 3 237 533 B1 discloses, for example, a polyethylene composition which has a base resin and an inorganic mineral filler, wherein the base resin comprises a first cross-linked polyethylene obtained from recycled cable waste and a second, fresh polyethylene in order to improve the mechanical properties of the product.

A discontinuous method for converting polyvinyl chloride into water-soluble CaOHCl at temperatures of less than 180° C. and with a reaction time of about three hours in a ball mill, wherein the CaOHCl is then washed out in a subsequent step, is known from document JP H11-124463.

Charging the pyrolysis reactor with solid plastics waste leads to a discontinuous process in which the plastics waste in the pyrolysis reactor must first be melted. Otherwise, complex metering units and systems are required for charging. This leads to a process which is unnecessarily energy intensive and time consuming. Furthermore, undesirable components, such as moisture (water) or polyvinyl chloride (PVC), are conveyed into the pyrolysis reactor. Even when the pyrolysis reactor is charged with plastic melt using a single-shaft extruder, the capacities, such as the throughput or the melt temperature, are very limited. The use of multiple single-shaft extruders and/or multiple pyrolysis reactors is necessary to obtain sufficient throughputs. However, this leads to an uneconomical and energy-intensive process.

End-consumer plastics waste (“post-consumer waste”) often contains polyvinyl chloride (PVC). However, halogens, such as chlorine or bromine, are a hindrance in the pyrolysis reactor as they can inhibit the pyrolysis process and may be deposited in the product. There is also the risk of corrosion. A post-treatment of the pyrolysis product is very complex and cost intensive. Halogen-containing compounds are therefore to be removed as best as possible before pyrolysis. Thermal stabilizers mean, for example, that the polyvinyl chloride can hardly degrade or degas within the residence time in a single-shaft extruder.

The object of embodiments of the disclosure is to functionally improve a method mentioned at the outset for processing plastics material, in particular thermoplastic material. In addition, the object of embodiments of the disclosure is to structurally and/or functionally improve a device mentioned at the outset for processing plastics material, in particular thermoplastic material.

It is therefore an object of embodiments of the disclosure to provide a processing method and a processing device which reduce or eliminate the problems indicated in connection with the prior art.

The object is achieved by a method having the features of claim 1. The object is also achieved with a device having the features of claim 11. Advantageous embodiments and/or developments are the subject matter of the dependent claims.

A method for processing plastics material, in particular thermoplastic material, such as plastics recycling material and/or plastics waste, may comprise the step: Supplying the plastics material into a screw-conveyor machine. The plastics material may be supplied continuously and/or metered. The plastics material may be supplied discontinuously. The plastics material may be supplied discontinuously in portions and continuously in portions. The plastics material may be supplied via a supply opening, in particular via a supply opening of the screw-conveyor machine. The supply opening may be a main supply opening, such as main inlet, of the screw-conveyor machine. The plastics material may be supplied by means of a charger, such as a charging device. The charger may be a side charger or side-charging device. The plastics material may be supplied by means of a supply device and/or metering device. The plastics material may be supplied into a feed zone and/or supply zone of the screw-conveyor machine. The plastics material may be plastics recycling material and/or plastics waste. The plastics material may have halogen-containing constituents/compounds. The plastics material may have polyolefins and/or polyvinyl chloride and/or polymers. The plastics material may be an agglomerate, such as plastics material agglomerate, and/or a recyclate and/or a granulate. The plastics material may be granulated and/or fibrous. The plastics material may have or be plastic granules and/or plastic fibers. The plastics material may be designed in the form of a film or as a film. The plastics material may be in the form of shreds. The plastics material may have and/or be shreds, such as film shreds. The plastics material may have and/or be plastic films and/or plastic film shreds, for example films and/or film shreds with low bulk density.

The method may comprise the step: Supplying an additive for converting organic chlorides into inorganic chlorides into the screw-conveyor machine. The additive may be added continuously and/or metered. The additive may be added discontinuously. The additive may be added discontinuously in portions and continuously in portions. The additive may be added via a supply opening, in particular via a supply opening of the screw-conveyor machine. The supply opening may be the main supply opening of the screw-conveyor machine. The additive may be supplied by means of a supply device and/or metering device. The additive may be supplied by means of a charger, such as a charging device. The charger may be a side charger or side-charging device. The additive may be added in a feed zone or supply zone or melting zone or mixing zone or degassing zone of the screw-conveyor machine and/or may be supplied to said zone(s). The additive may be added downstream of a main supply opening of the screw-conveyor machine and/or downstream of a feed zone of the screw-conveyor machine. The additive may be added via the supply opening and/or with the supply device and/or metering device and/or charger, such as a side charger, for supplying the plastics material. The additive and the plastics material may be supplied via the same supply opening and/or with the same supply device and/or metering device and/or charger, such as a side charger. The additive and the plastics material may be supplied simultaneously or together or separately from one another or one after the other. The additive and the plastics material may be supplied together or separately. The additive may be supplied together with the plastics material. The additive may be supplied after or before the supply of the plastics material. The additive may be an auxiliary and/or an additive. The additive may be powdered, granulated or liquid. The additive may be a metal chloride, a metal oxide, a metal hydroxide, a metal stearate, a zeolite, or a carbonate. The additive may comprise a metal chloride and/or a metal oxide and/or a metal hydroxide, and/or metal stearate(s) and/or a zeolite and/or a carbonate. The additive or the metal oxide may be, for example, calcium oxide (CaO) or magnesium oxide (MgO). The additive or the metal oxide may be, for example, burnt lime or quick lime. The additive or the metal hydroxide may be, for example, calcium hydroxide (CA(OH)₂) or magnesium hydroxide Mg(OH)₂. The additive may be or have, for example, an alkaline earth oxide or alkali oxide. The additive or the carbonate may be, for example, hydrogen carbonate.

The method may comprise the step: Plasticizing the supplied plastics material by means of the screw-conveyor machine to form a plastics melt. The plasticizing may be a melting of the plastics material. The plasticizing may take place in the melting zone and/or mixing zone of the screw-conveyor machine. The plastics melt may have a temperature between 100° C. and 400° C., for example between 300° C. and 400° C. or between 200° C. and 350° C., in particular between 280° C. and 330° C., for example about 320° C. The plasticizing may take place by means of at least one treatment element shaft of the screw-conveyor machine. The plasticizing may take place, for example, by means of two treatment element shafts of the screw-conveyor machine. The screw-conveyor machine may be a multi-shaft screw-conveyor machine, e.g., a twin-shaft screw-conveyor machine. The screw-conveyor machine may be designed as a multi-shaft screw-conveyor machine, which is rotationally driven in the same direction or in opposite directions and/or intermeshes, and/or may be or is driven in such a way. The screw-conveyor machine may be an extruder, in particular a multi-screw extruder, such as a twin-screw extruder.

The method may comprise the step: Mixing the plastics melt with the supplied additive by means of the screw-conveyor machine to form a mixture. The mixing may take place in a melting zone and/or a mixing zone of the screw-conveyor machine. The mixing may take place with the at least one treatment element shaft of the screw-conveyor machine. The mixing may be, for example, distributive mixing, dispersive mixing, and/or discontinuous mixing. The at least one treatment element shaft may have screw elements, such as conveying and/or mixing and/or baffle and/or kneading elements. The plasticizing of the plastics material and the mixing of the plastics melt with the supplied additive may take place substantially simultaneously, for example within a zone, such as a melting zone and/or mixing zone, the screw-conveyor machine, or one after the other. The mixing zone may be provided downstream of the melting zone.

During the plasticizing of the plastics material and/or during mixing of the plastics melt with the additive, at least some of the organic chlorides contained in the plastics melt may be converted into inorganic chlorides by means of the additive. The method may comprise the step: Converting at least some of the organic chlorides contained in the plastics melt into inorganic chlorides by means of the additive. The conversion may take place during the plasticizing of the plastics material and/or during the mixing of the plastics melt with the additive. The conversion may take place in the melting zone and/or mixing zone of the screw-conveyor machine. The conversion may result, for example, in the polyvinyl chloride present in the plastics melt being degraded or decomposed.

The additive may act as a catalyst and/or reactant, for example for chlorides and/or hydrogen chloride. The additive may act as a catalyst for chlorides. The additive may act as a reactant for hydrogen chloride, such as hydrogen chloride gas.

During the plasticizing and/or mixing and/or conversion by means of the additive as catalyst, hydrogen chloride, in particular hydrogen chloride gas, may be formed. For example, the degradation or decomposition of polyvinyl chloride can take place catalytically or be accelerated by means of the state substance. The decomposition or degradation can be represented, for example, as follows:

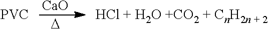

In addition to water (H₂O), carbon dioxide (CO₂) and/or hydrocarbons (CₙHₘ), such as alkanes (CₙH₂ₙ₊₂) or alkenes (CₙH₂ₙ), hydrogen chloride (HCl) may be released or be formed.

In the method, a degassing of the plastics melt and/or of the mixture in the screw-conveyor machine may be provided, for example by means of at least one degassing device arranged on the screw-conveyor machine. The degassing can take place continuously and/or simultaneously with the plasticizing and/or mixing and/or conversion. Multiple degassings may take place or degassing devices be provided. At least one degassing can take place in the melting zone, the mixing zone or a degassing zone of the screw-conveyor machine. The at least one degassing device may be designed as a vacuum degassing unit and/or side degassing unit and/or as a degassing dome and/or stuffing screw. The at least one degassing device may have a retaining unit, such as a melt retaining device or a melt retaining unit. The degassing may be used to remove volatile constituents, such as water, e.g., water vapor, or gases, e.g., hydrocarbons or hydrogen chlorides, which, for example, arise during the plasticization and/or mixing and/or conversion and/or escape from the plastics melt, and/or to discharge/extract such through a degassing opening of the screw-conveyor machine. At least some of the hydrogen chloride or hydrogen chloride gas formed during the conversion may be removed or extracted by means of degassing.

During the plasticizing and/or mixing and/or conversion, an inorganic chloride, for example calcium chloride or magnesium chloride, may be formed by means of the additive as a reactant. For example, the additive, such as calcium oxide (CaO), can react with at least some of the hydrogen chloride (HCl) or hydrogen chloride gas (HCl) formed during the conversion, in particular with formation of an inorganic chloride, such as calcium chloride (CaCl₂)). This reaction may be shown, for example, as follows:

CaO+2HCl→CaCl₂)+H₂O

The additive may thus function both as a catalyst and as a reactant. Calcium chloride (CaCl₂)) or magnesium chloride (MgCl₂) can arise or be formed. Calcium chloride or magnesium chloride is uncritical to the further method of the pyrolysis and may be conveyed into a pyrolysis reactor without any concern. The boiling point of calcium chloride can, at about 1670° C., be significantly higher than an operating temperature of a pyrolysis reactor. As a result, fewer or no chlorides may be passed into a distillation.

The plastics melt or mixture processed in the screw-conveyor machine may be discharged as a melt, for example at the downstream end of a discharge zone of the screw-conveyor machine. The processed melt may be discharged through a discharge opening/outlet opening, for example through a nozzle plate, of the screw-conveyor machine. The plastics melt or mixture processed in the screw-conveyor machine may be supplied as a melt to a pyrolysis reactor, in particular directly. The nozzle plate or discharge opening of the screw-conveyor machine may be connected, for example directly or via a supply line, to a supply or input opening of the pyrolysis reactor.

A device for processing plastics material, in particular thermoplastic material, such as plastic recycling material and/or plastic waste, may comprise a screw-conveyor machine. The device may be used for processing thermoplastic plastics material, plastics recycling material and/or plastics waste. The device may be a preparation device, such as a plastics preparation device. The device may be designed or further developed with one or more features described with respect to the method. The device may be used to treat and/or process waste plastic. The device may be used for recycling purposes, in particular for the purpose of recycling plastics. The device may be used for pretreating and/or conveying, plasticizing, melting, mixing, agglomerating or granulating plastics material and/or may be designed for this purpose.

The screw-conveyor machine may comprise, in particular in the conveying direction, a feed zone and/or supply zone and/or melting zone and/or mixing zone, and/or degassing zone and/or discharge zone. The screw-conveyor machine may have a compression zone. The melting zone may be provided or arranged downstream of the feed zone and/or supply zone. The mixing zone may be provided or arranged downstream of the melting zone. The discharge zone may be provided or arranged downstream of the mixing zone. The plastics material and/or the additive may be supplied in the feed zone/supply zone. The plastics material may be melted in the melting zone. The plastics material may be compacted in the compression zone. The plastics material may be mixed in the mixing zone. The plastics material may be mixed with the additive in the mixing zone. The plastics material may be degassed in the degassing zone. The plastics material may be homogenized and/or pressurized in the discharge zone.

The screw-conveyor machine may have at least one supply opening for supplying the plastics material into the screw-conveyor machine. The screw-conveyor machine may have at least one supply opening for supplying an additive for converting organic chlorides into inorganic chlorides into the screw-conveyor machine. The screw-conveyor machine may have a supply opening, such as a main supply opening or main inlet, for supplying the plastics material and for supplying an additive into the screw-conveyor machine. The screw-conveyor machine may have one or more supply openings. The at least one supply opening may be associated with or open into the feed zone and/or supply zone and/or melting zone and/or mixing zone and/or degassing zone.

The screw-conveyor machine may have at least one supply device and/or metering device. The at least one supply device and/or metering device may be associated with the at least one supply opening or be operatively connected thereto. The at least one supply device and/or metering device may be used or designed for metered and/or continuous supplying of the plastics material and/or the additive into the screw-conveyor machine.

The at least one supply device and/or metering device may be designed to receive the plastics material. The at least one supply device and/or metering device may have at least one funnel, such as a filling funnel. The at least one supply device and/or metering device may, for example, have two funnels, such as filling funnels. The at least one supply device and/or metering device may, for example, have a funnel, such as a filling funnel, for supplying the plastics material and a funnel, such as a filling funnel, for supplying the additive The at least one supply device and/or metering device may have a holding tank or storage container. The at least one supply device and/or metering device may be designed for metered and/or continuous dispensing of the plastics material and/or of the additive. The at least one supply device and/or metering device may be designed to meter the plastics material and/or the additive gravimetrically or volumetrically and/or to supply it continuously. The at least one supply device and/or metering device may have a supply screw-conveyor machine and/or metering screw-conveyor machine. The at least one supply device and/or metering device may have a gravimetric or volumetric metering unit, such as a metering scale. The metering unit may be a belt weigher. The metering unit may be operated gravimetrically or volumetrically. The at least one supply device and/or metering device and/or the metering unit may be designed to detect, in particular exactly, the material stream, the volume and/or the weight of at least some of the plastics material or of the plastics recycling material and/or of the additive.

The screw-conveyor machine may have a housing, such as a cylinder housing. The housing may be designed in one piece or multiline. The housing may be a process section. The housing may have multiple housing portions or housing parts. The housing portions or housing parts may be arranged one after the other and/or connected to one another to form the housing. At least one housing bore may be formed in the housing. Two mutually parallel housing bores that overlap and penetrate one another may be designed in the housing. The two housing bores may have the shape of a horizontal figure of eight in cross section. The screw-conveyor machine may have at least one funnel, such as a filling funnel. The funnel may be the main inlet of the screw-conveyor machine. The funnel may be arranged on the housing of the screw-conveyor machine. The funnel may be operatively connected to at least one supply opening. The funnel may be used to supply the plastics material and/or additive. The at least one supply device and/or metering device may feed the plastics material to the funnel of the screw-conveyor machine and/or supply such continuously. The housing of the screw-conveyor machine may have the at least one supply opening which opens into the at least one housing bore. The at least one supply opening may be operatively connected to the funnel. The housing of the screw-conveyor machine may have at least one degassing opening which opens into the at least one housing bore.

The screw-conveyor machine may be designed to melt and/or plasticize the plastics material supplied to it by the at least one supply device and/or metering device. The screw-conveyor machine may have at least one treatment element shaft for plasticizing/melting the supplied plastics material to form a plastics melt. The at least one treatment element shaft may be designed to plasticize/melt the supplied plastics material to form a plastics melt. The at least one treatment element shaft may be designed to mix the plastics melt with the supplied additive to form a mixture, in particular such that at least some of the organic chlorides contained in the plastics melt may be converted into inorganic chlorides by means of the additive. The at least one treatment element shaft may be an extruder shaft or extruder screw. The at least one treatment element shaft may have a diameter, such as an outer diameter. The at least one treatment element shaft may have a processing length. The processing length may be at least 32 times the diameter, in particular at least 48 times the diameter. The processing length may be >32 L/D, and, in embodiments, >48 L/D. The at least one treatment element shaft may have screw elements. The screw elements may be arranged on the at least one treatment element shaft in a rotationally fixed manner, e.g., pinned. The screw elements may comprise conveying elements, such as forward-conveying or returning elements, and/or shearing elements and/or baffle elements and/or kneading elements and/or mixing elements. The kneading elements may be designed as individual kneading discs or as at least one kneading block with multiple kneading discs integrally connected to one another. The at least one treatment element shaft may be arranged in the housing, in particular in the housing bore, of the screw-conveyor machine. A treatment element shaft may be arranged in each housing bore of the screw-conveyor machine. The multiple treatment element waves, in particular the two treatment element shafts, may be arranged concentrically. The at least one treatment element shaft may be rotationally driven by a drive motor about an associated axis of rotation. At least one branching transmission and/or one coupling may be effectively arranged between the treatment element shafts. The multiple treatment element shafts, in particular the two treatment element shafts, may be driven in the same direction, i.e., in the same directions of rotation, or in opposite directions, i.e., in opposite directions of rotation, about the axes of rotation.

The screw-conveyor machine may be designed as a multi-shaft screw-conveyor machine, in particular twin-shaft screw-conveyor machine. The screw-conveyor machine may have multiple treatment element shafts, for example two treatment element shafts.

The screw-conveyor machine may be designed as a multi-shaft screw-conveyor machine which is rotationally driven in the same direction/co-rotating or in opposite directions/counter-rotating and/or intermeshes, and/or may be or is driven in such a way. The screw-conveyor machine may be an extruder, in particular a multi-screw extruder, such as a twin-screw extruder. The multiple treatment element shafts, for example the two treatment element shafts, may be or are rotationally driven in the same direction or in opposite directions. The multiple treatment element shafts, in particular the two treatment element shafts, may intermesh tightly.

The device may have at least one degassing device. The at least one degassing device may be arranged on the screw-conveyor machine. The at least one degassing device may be designed for degassing the plastics melt or the mixture formed in the screw-conveyor machine. The at least one degassing device may be designed as a forward degassing device and/or as a reverse degassing device. Multiple degassing devices may be provided. The at least one degassing device may be operatively arranged in the melting zone, the mixing zone, the degassing zone or the discharge zone of the screw-conveyor machine or may be associated with said zone(s). The at least one degassing device may be designed as a vacuum degassing unit and/or side degassing unit and/or as a degassing dome and/or stuffing screw. The at least one degassing device may have a retaining unit, such as a melt retaining device or a melt retaining unit. The at least one degassing device may be heated or have a heating unit. For example, two or three heated vacuum degassing units may be provided with a melt retaining unit, such as a side degasser. The at least one degassing device may generate a vacuum with an absolute pressure between 0 mbar and 1000 mbar, in particular between 10 mbar and 800 mbar, and in particular between 20 mbar and 400 mbar. For example, the at least one degassing device may be designed to generate a vacuum with an absolute pressure of approximately 100 mbar. The at least one degassing device may be designed to generate a defined volume flow, for example approximately 20 m³/h. The degasser or the at least one degassing device may be used to remove volatile components, such as water, e.g., water vapor, or gases, e.g., hydrocarbons or hydrogen chlorides, which, for example, arise during the plasticization and/or mixing and/or conversion and/or escape from the plastics melt, and/or to discharge/extract through a degassing opening of the screw-conveyor machine. At least some of the hydrogen chloride or hydrogen chloride gas formed during the conversion may be removed or extracted by means of degassing or by means of the at least one degassing device.

The screw-conveyor machine may have a discharge opening/outlet opening, in particular at its downstream end, for example at the downstream end of the discharge zone. The discharge opening/outlet opening may be designed such that the processed plastics melt may be discharged from the interior of the screw-conveyor machine through the discharge opening/outlet opening. A tool, in particular a shaping tool, such as a molding tool, may be arranged at the discharge opening/outlet opening. The discharge opening/outlet opening may be formed by a nozzle plate. The plastics melt or mixture processed in the screw-conveyor machine may be supplied as a melt to a pyrolysis reactor, in particular directly. The discharge opening/outlet opening of the screw-conveyor machine may be connected, for example directly and/or via a supply line, to a supply or input opening of the pyrolysis reactor. The screw-conveyor machine and/or the supply line may be designed to supply the processed plastics melt to the pyrolysis reactor, in particular continuously.

A further aspect relates to the use of the device described above and/or below for processing and/or recycling plastics material, in particular thermoplastic material, such as plastics recycling material and/or plastic waste, wherein at least some of the organic chlorides contained in the plastics melt are converted into inorganic chlorides by means of the additive.

In summary and in other words, embodiments of the disclosure thus produce, inter alia, a method and a device for separating off halogenated hydrocarbons from plastics waste (“post-consumer waste”). An additive, such as a dope, which can bring about and/or promote separation may be added. The additive may be a metal chloride or metal oxide, such as calcium oxide (e.g., burnt lime). The device may be a twin-screw extruder. The twin-screw extruder may apply the necessary energy, for example via shearing. In order to introduce as much energy as possible into the product and/or reach a target temperature between 100° C. and 400° C., for example between 300° C. and 400° C. or between 200° C. and 350° C., in particular between 280° C. and 330° C., for example >320° C., up to 380° C., the processing length of the device or of the twin-screw extruder is >32 L/D, and, in embodiments, >48 L/D. In order to remove volatile constituents, such as water or the gases resulting from degradation, such as hydrocarbons or hydrogen chlorides, from the process and not to convey them into the pyrolysis reactor, at least one, in embodiments two or three, heated vacuum degasser may be provided with a melt retaining unit, such as a side degasser. A combination of machine technology and additive may optimize the process. By adding the chemical compound or the additive, the degradation of the polyvinyl chloride may be accelerated. The additive may be added in the main inlet of the device or of the twin-screw extruder. The degradation of the polyvinyl chloride in the plastics waste may be catalytically accelerated by means of the additive. In addition to water, carbon dioxide, and hydrocarbons, hydrogen chloride may also be released. In part, said hydrogen chloride may be extracted via the vacuum degasser. The predominant portion of the hydrogen chloride may react with the additive, such as calcium oxide, for example to form calcium chloride. The additive may thus function both as a catalyst and as a reactant. The calcium chloride predominantly resulting is uncritical and may be conveyed into the pyrolysis reactor without any concern, since the boiling point of calcium chloride at 1670° C. is significantly above the operating temperature of the pyrolysis reactor.

Embodiments of the disclosure may ensure that no or at least only a few chlorides are passed into the distillation. The throughput performance may be increased, for example up to 10,000 kg/h may be continuously achieved, in particular by means of an extruder. A very good mixing effect and/or homogenization, in particular of the additive and/or of the plastics melt, may be achieved. Energy may be introduced directly into the plastics material via friction and brought to the target temperature within a short time, for example in 10 to 180 seconds, for example in 20 to 120 seconds, in particular in 30 to 90 seconds. There is no need for an additional external heating. Energy efficiency may be increased. The reaction can proceed uniformly and rapidly. High rates of surface renewal and/or better degassing may be facilitated. The degradation of polyvinyl chloride may be accelerated. Organic chlorine or chloride may be efficiently removed from plastics waste. The method can take place continuously and/or in one step. Shorter residence times at high target temperatures are possible. A very high proportion of the pyrolysis may take place in the pyrolysis reactor. The yield in the pyrolysis reactor may be increased. Heat energy present in the melt may be further exploited. The device, the method, and the pyrolysis are more energy-efficient. A smaller machine size with higher filling levels and/or throughputs may be realized. Organic chlorides may be converted into inorganic chlorides with significantly higher boiling temperatures. The additive, such as the excess calcium oxide, allows efficient conversion to take place, for example conversion into uncritical calcium chloride, which does not inhibit the pyrolysis process and/or may be discharged from the bottom at the end. Less cleaning effort and/or maintenance work in the pyrolysis reactor and/or the distillation columns may be ensured. Costs may be saved.

Exemplary embodiments of the disclosure are described in more detail below with reference to figures, in which the following are shown schematically and by way of example:

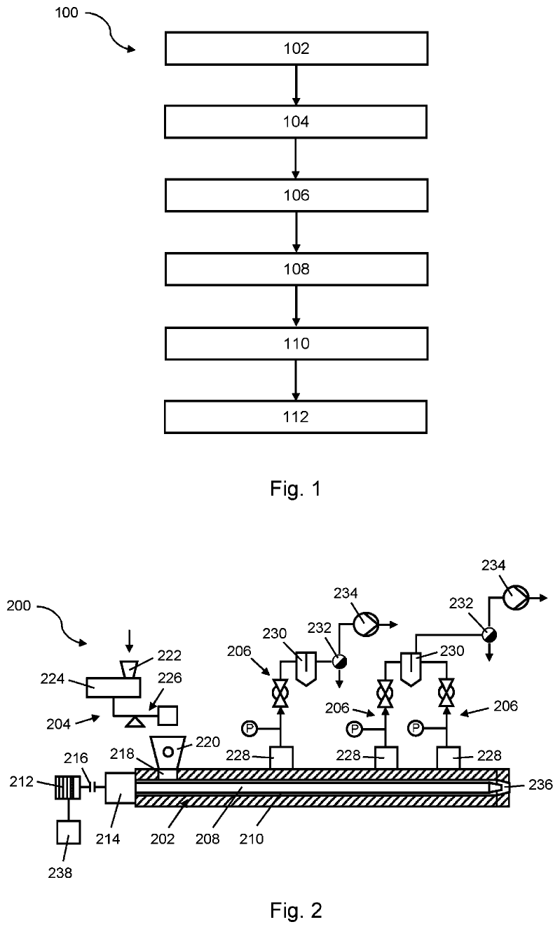

FIG. 1 a method for processing plastics material, in particular thermoplastic material; and

FIG. 2 a device for processing plastics material, in particular thermoplastic material.

FIG. 1 schematically shows a method 100 for processing plastics material, in particular thermoplastic material, such as plastics recycling material and/or plastic waste.

In a step 102, the plastics material is supplied into a screw-conveyor machine. The supply of the plastics material may be supplied via a supply opening, in particular a main supply opening, of the screw-conveyor machine, in particular a feed zone of the screw-conveyor machine. The plastics material may be supplied continuously by means of a supply device and/or metering device. The plastics material may, for example, have polyvinyl chloride.

In a step 104, an additive for converting organic chlorides into inorganic chlorides is supplied into the screw-conveyor machine. The supply of the additive may be supplied via the supply opening, in particular the main supply opening, of the screw-conveyor machine, in particular the feed zone of the screw-conveyor machine. The additive may be supplied discontinuously or continuously by means of the supply device and/or metering device. The additive may be a metal chloride, metal hydroxide, metal stearate, zeolite, carbonate or metal oxide, such as calcium oxide or magnesium oxide. The additive may be in powder form. The feed steps 102 and 104 may be carried out simultaneously or separately.

In a step 106, the supplied plastics material is plasticized or melted by means of the screw-conveyor machine to form a plastics melt. The plastics melt may be brought to a target temperature between 300° C. and 400° C., in particular approximately 320° C. The plasticizing can take place by means of at least one treatment element shaft arranged in a rotatable manner in the screw-conveyor machine. For example, the screw-conveyor machine is a twin screw extruder with two treatment element shafts rotating in the same direction and intermeshing, which have multiple process-specific screw elements.

In a step 108, the plastics melt is mixed with the supplied additive by means of the screw-conveyor machine to form a mixture, wherein at least some of the organic chlorides contained in the plastics melt are converted into inorganic chlorides by means of the additive. A conversion step for converting at least some of the organic chlorides contained in the plastics melt into inorganic chlorides by means of the additive may also be provided. The conversion step may be carried out simultaneously with the mixing step 108 and/or plasticizing step 106. The additive may act as a catalyst and/or reactant. During the plasticizing and/or mixing, hydrogen chloride, in particular hydrogen chloride gas, may be formed by means of the additive as catalyst, and an inorganic chloride, for example calcium chloride or magnesium chloride, may be formed by means of the supplied additive as reactant. In this case, for example, polyvinyl chloride may be catalytically converted into water, carbon dioxide, hydrocarbons, and hydrogen chloride using the calcium oxide or magnesium oxide. At least some of the hydrogen chloride then reacts further with the calcium oxide or magnesium oxide to form water and calcium chloride or magnesium chloride. Calcium chloride or magnesium chloride is not critical for a subsequent pyrolysis process.

In a step 110, the plastics melt or the mixture formed is degassed in the screw-conveyor machine by means of at least one degassing device arranged on the screw-conveyor machine. The degassing device may be a vacuum side degasser with a retaining unit, such as a melt retaining unit. By means of the degasser or degassing device, at least some of the hydrogen chloride gas formed may be removed or extracted. The degassing step 110 may take place continuously and/or simultaneously with the plasticizing step 106 and/or mixing step 108 and/or converting step. Multiple, such as two or three, degassing devices may be provided.

In a step 112, the plastics melt or mixture processed in the screw-conveyor machine can then be discharged as a melt and/or supplied to a pyrolysis reactor.

FIG. 2 schematically shows a device 200 for processing plastics material, in particular thermoplastic material, such as plastics recycling material and/or plastic waste. The device 200 may be used to carry out the method described above and/or below and/or be designed for this purpose.

The device 200 has a screw-conveyor machine 202, a supply device and/or metering device 204 and at least one degassing device 206.

The screw-conveyor machine 202 is designed as a twin-shaft screw-conveyor machine, such as a twin-screw extruder, and has two treatment element shafts 208 with multiple screw elements. The treatment element shafts 208 each have a diameter and a processing length, wherein the processing length is at least 32 times the diameter, in particular at least 48 times the diameter. The two treatment element shafts 208 are arranged in two mutually overlapping housing bores 210 which have the shape of a horizontal figure of eight in cross section. The treatment element shafts 208 are arranged in the housing bores 210 concentrically with respect to associated axes of rotation. The treatment element shafts 208 are designed to rotate in the same direction and to intermesh. The treatment element shafts 208 are driven by means of an electric drive motor 212. A branching transmission 214 and a coupling 216 are arranged between the treatment element shafts 208 and the drive motor.

The screw-conveyor machine 202 also has a supply opening 218 to which a main filling funnel 220 is connected and which opens into the housing bores 210. The supply opening 218 serves to supply the plastics material and the additive for converting organic chlorides into inorganic chlorides into the screw-conveyor machine 202. The main filling funnel 220 is fed with plastics material and the additive by the supply device and/or metering device 204. Additionally or alternatively, the screw-conveyor machine 202 may have a side charger which is designed to supply the plastics material and/or additive.

The supply device and/or metering device 204 has at least one filling funnel 222, via which the plastics material, such as plastic recycling agglomerate, and the additive may be supplied. The additive is, for example, powdery. The additive may be a metal chloride, metal hydroxide, metal stearate, zeolite, carbonate or metal oxide, such as calcium oxide or magnesium oxide. The supply device and/or metering device 204 also has a holding tank or storage container 224 and a metering device 226, which is operated gravimetrically or volumetrically and which can supply the plastics material and/or the additive continuously and/or metered to the main filling funnel 220 of the screw-conveyor machine 202.

The treatment element shafts 208 are designed to plasticize the supplied plastics material to form a plastics melt and to mix the plastics melt with the supplied additive to form a mixture, wherein at least some of the organic chlorides contained in the plastics melt may be converted into inorganic chlorides by means of the additive. During the plasticizing and/or mixing, hydrogen chloride, in particular hydrogen chloride gas, may be formed by means of the supplied additive as catalyst, and an inorganic chloride, for example calcium chloride or magnesium chloride, may be formed by means of the supplied additive as reactant. In this case, for example, polyvinyl chloride may be catalytically converted into water, carbon dioxide, hydrocarbons, and hydrogen chloride using the calcium oxide or magnesium oxide. At least some of the hydrogen chloride then reacts further with the calcium oxide or magnesium oxide to form water and calcium chloride or magnesium chloride.

The at least one degassing device 206 is arranged on the screw-conveyor machine 202 and is designed for degassing the plastics melt or the mixture formed in the screw-conveyor machine 202. The at least one degassing device 206 may be heated or have a heating unit. The at least one degassing device 206 is designed as a vacuum side degasser which has a retaining unit, such as a melt retaining unit, 228, a separator 230, a condenser 232, and a suction pump 234. Gaseous liquids can condense in the condenser 232. The at least one degassing device 206 may be attached laterally to a degassing opening of the screw-conveyor machine 202. By means of the degasser or degassing device, at least some of the hydrogen chloride gas formed may be removed or extracted. The at least one degassing device 206 is designed to carry out degassing continuously and/or simultaneously during the plasticizing and/or mixing and/or conversion. In the present embodiment, the device 200 has three degassing devices 206 arranged one behind the other downstream and having substantially the same design. Two of the degassing devices 206, for example the two degassing devices 206 arranged downstream of the first degassing device 206, may be operatively interconnected.

Furthermore, the screw-conveyor machine 202 has, at its downstream end, an outlet opening 236 which is designed such that the processed plastics melt may be discharged from the interior of the screw-conveyor machine 202 through the outlet opening 236.

For control, the device 200 has a control device 238. In particular, the screw-conveyor machine 202, the supply device and/or metering device 204 and/or the degassing devices 206 may be controlled by means of the control device 238.

In addition, reference is made in particular to FIG. 1 and the associated description.

“May” refers in particular to optional features of embodiments. Accordingly, there are also developments and/or exemplary embodiments which additionally or alternatively have the respective feature or the respective features.

From the feature combinations disclosed in herein, isolated features may also be singled out as required and, by resolving an optionally existing structural and/or functional relationship between the features in combination with other features, be used to delimit the subject matter of the claim. The order and/or number of method steps may be varied.

### REFERENCE SIGNS

100 Processing method
102 Step for supplying the plastics material
104 Step for supplying the additive
106 Step for plasticizing the plastics material
108 Step for mixing the plastics melt with the additive
110 Step for degassing the plastic melt or mixture
112 Step for discharging and/or supplying the melt
200 Processing device
202 Screw-conveyor machine
204 Supply device and/or metering device
206 Degassing devices
208 Treatment element shafts
210 Housing bores
212 Drive motor
214 Branching transmission
216 Coupling
218 Supply opening
220 Main filling funnel of the screw-conveyor machine
222 Filling funnel of the supply device and/or metering device
224 Holding tank or storage container
226 Metering device
228 Melt retaining unit
230 Separator
232 Condenser
234 Suction pump
236 Outlet opening
238 Control device

1. A method for processing plastics material, comprising the following steps;
supplying the plastics material into a screw-conveyor machine;
supplying an additive for converting organic chlorides into inorganic chlorides into the screw-conveyor machine;
plasticizing the supplied plastics material with the screw-conveyor machine to form a plastics melt; and
mixing the plastics melt with the supplied additive with the screw-conveyor machine to form a mixture, wherein at least some of the organic chlorides contained in the plastics melt are converted into inorganic chlorides by the additive.

2. The method according to claim 1, wherein the additive comprises a metal chloride, a metal stearate, a metal oxide, a metal hydroxide, a zeolite, or a carbonate.

3. The method according to claim 1, wherein the additive acts as a catalyst and/or reactant.

4. The method according to claim 1, wherein hydrogen chloride is formed by the additive as catalyst during the plasticizing and/or mixing.

5. The method according to claim 1, wherein an inorganic chloride, is formed by the additive as reactant during the plasticizing and/or mixing.

6. The method according to claim 1, wherein the plastics melt has a temperature between 100° C. and 400° C.

7. The method according to claim 1, wherein the additive is supplied via a supply opening to the screw-conveyor machine.

8. The method according to claim 1, wherein the additive is supplied via a supply opening to the screw-conveyor machine.

9. The method according to claim 1, wherein a degassing of the plastics melt or of the formed mixture takes place in the screw-conveyor machine by at least one degassing device arranged on the screw-conveyor machine.

10. The method according to claim 1, wherein the plastics melt or mixture processed in the screw-conveyor machine is discharged as melt and/or supplied to a pyrolysis reactor.

11. The method according to claim 1, wherein the screw-conveyor machine is a multi-shaft screw-conveyor machine.

12. A device for processing plastics material, comprising a screw-conveyor machine having
at least one supply opening for supplying the plastics material and/or an additive for converting organic chlorides into inorganic chlorides into the screw-conveyor machine; and
at least one treatment element shaft for plasticizing the supplied plastics material to form a plastics melt and for mixing the plastics melt with the supplied additive to form a mixture, wherein at least some of the organic chlorides contained in the plastics melt are converted into inorganic chlorides by the additive.

13. The device according to claim 12, wherein the at least one treatment element shaft has a diameter and a processing length, wherein the method length is at least 32 times the diameter.

14. The device according to claim 12, wherein the screw-conveyor machine is designed as a multi-shaft screw-conveyor machine.

15. The device according to claim 12, wherein the device has at least one degassing device which is arranged on the screw-conveyor machine and is designed for degassing the plastics melt or the mixture formed in the screw-conveyor machine.

16. A use of the device according to claim 12, wherein at least some of the organic chlorides contained in the plastics melt are converted into inorganic chlorides by the additive.
